(19) United States
(12) Patent Application Publication
(10) Pub. No.: US 2014/0054054 A1
(43) Pub. Date: Feb. 27, 2014

(54) BATTERY OPERATED TOOL

(71) Applicants: Ian Osborne, Hillsboro, OR (US); Jonathan Ziring, Portland, OR (US); Shaun Conley, Portland, OR (US); Guenther Wimmer, West Linn, OR (US)

(72) Inventors: Ian Osborne, Hillsboro, OR (US); Jonathan Ziring, Portland, OR (US); Shaun Conley, Portland, OR (US); Guenther Wimmer, West Linn, OR (US)

(73) Assignee: Blount, Inc., Portland, OR (US)

(21) Appl. No.: 14/002,631

(22) PCT Filed: Mar. 5, 2012
(86) PCT No.: PCT/US12/27792

§ 371 Date: Nov. 6, 2013

Related U.S. Application Data
(60) Provisional application No. 61/449,568, filed on Mar. 4, 2011.

(51) Int. Cl. B25F 5/00

(52) U.S. Cl. CPC B25F 5/00
USPC 173/2; 173/217

(57) ABSTRACT

Embodiments provide methods, apparatuses, and systems for battery operated tools, such as chainsaws, are provided. In accordance with embodiments herein, a chainsaw may include various components, such as a control board having a controller, a battery terminal block, a motor, a brake switch, a trigger switch, and/or other components. In various embodiments, components of the battery operated tool are provided that improve the capabilities and/or operation of the tool.

### CROSS REFERENCE TO RELATED APPLICATIONS

The present application claims priority to U.S. Provisional Patent Application No. 61,449,568, filed Mar. 4, 2011, titled “BATTERY OPERATED TOOL,” the entire disclosure of which is hereby incorporated by reference in its entirety except for those sections, if any, that are inconsistent with this specification.

### TECHNICAL FIELD

Embodiments herein relate to the field of tools, and, more specifically, to battery operated tools.

### BACKGROUND

Batteries are widely used to operate tools, such as battery operated chainsaws, due to the freedom of not requiring a connection to a power extension cord or requiring the user to refill a fuel tank. However, battery operated tools have many challenges, such as battery storage, power management, and thermal management.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 illustrates a schematic block diagram of components of a battery operated tool in accordance with various embodiments;

FIG. 2A illustrates a battery and a battery compartment in accordance with various embodiments;

FIG. 2B illustrates a front view of a battery compartment in accordance with various embodiments;

FIG. 2C illustrates a battery fully inserted into a battery compartment, in accordance with various embodiments;

FIG. 2D illustrates a battery partially inserted into a battery compartment in accordance with various embodiments;

FIG. 3A illustrates a brake assembly with an electronic switch in a deactivated state in accordance with various embodiments;

FIG. 3B illustrates the brake assembly with the electronic switch in an activated state in accordance with various embodiments;

FIG. 3C illustrates a brake paddle of the brake assembly in accordance with various embodiments;

FIGS. 4A-D illustrate graphs of various parameters of a tool versus an workload applied to the tool load for a control system in accordance with various embodiments compared with a conventional battery operated tool, including plots of: (A) motor output power; (B) motor speed; (C) battery current; and (D) motor current;

FIG. 5A illustrates a motor cover in accordance with various embodiments;

FIG. 5B illustrates internal components of a chainsaw in accordance with various embodiments;

FIG. 6 illustrates a block diagram of a control board having a plurality of field-effect transistors (FETs) coupled to a heat sink in accordance with various embodiments;

FIG. 7A illustrates a top view of a battery operated chainsaw showing the center of gravity in accordance with various embodiments; and

FIG. 7B illustrates a side view of a battery operated chainsaw showing the center of gravity in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In various embodiments, methods, apparatuses, and systems for battery operated chainsaws are provided. In exemplary embodiments, a computing device may be endowed with one or more components of the disclosed apparatuses and/or systems and may be employed to perform one or more methods as disclosed herein.

Embodiments herein provide various components of a battery operated tool, such as a battery operated chainsaw. Various embodiments are described in the context of a chainsaw, however it will be apparent to one skilled in the art that suitable embodiments may extend to use in other battery operated tools. Other such tools include hedge trimmers, line trimmers, etc.

In embodiments, the chainsaw may include various components, such as a controller, a battery terminal block, a motor, a brake switch, a trigger switch, and/or other components. The controller may be operatively coupled to one or more of the remaining components. The chainsaw may further include a battery coupled to the battery terminal block, through a battery compartment, to supply power, e.g., current and/or voltage, to the motor. The motor may drive a saw chain as it traverses a guide bar of the chainsaw. The trigger switch may be used to selectively route power to the motor to drive the saw chain. The chainsaw may further include a front handle and/or a rear handle coupled to a housing of the chainsaw and adapted to be grasped by a user.

In various embodiments, as discussed below, various components of the battery operated tool are provided that improve the capabilities and/or operation of the tool.

### Control Board Device Detection and Communication Terminal

In various embodiments, a battery-powered handheld tool may include an electric motor, a controller coupled to the electric motor, and a multipurpose terminal coupled to the controller. The multipurpose terminal may be used to couple various external devices (e.g., accessories) to the tool, such as a battery, a diagnostic device, and/or a test device. In some embodiments, the battery may be a standard battery or an extended battery (e.g., providing a higher battery capacity). The multipurpose terminal block may include at least one multipurpose contact. The controller may identify the external device (e.g., as one of a category of devices) and communicate with the external device via the multipurpose contact. The multipurpose terminal may further include a pair of power contacts for routing power to the motor (e.g., via the controller).

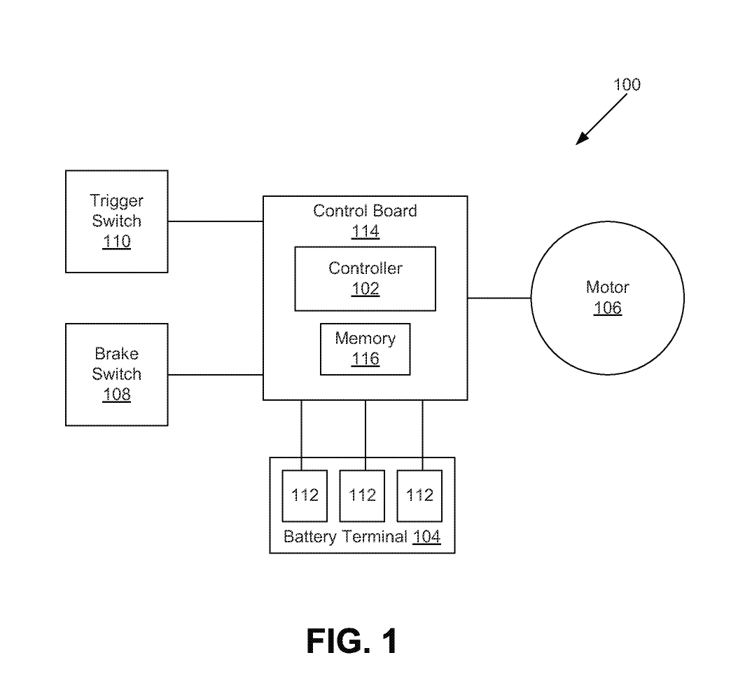

FIG. 1 is a block diagram showing various components of a chainsaw 100. The chainsaw 100 includes a controller 102 operatively coupled with other components of the chainsaw 100, including a multipurpose terminal block 104, a motor 106, a brake switch 108, and a trigger switch 110. The multipurpose terminal block 104 includes a plurality of terminals 112a-c. In various embodiments, one or more external devices (e.g., accessories) may be coupled to the terminal block 104, such as a standard battery, an endurance battery, a diagnostic device, and/or a test device. The controller 102 may be configured to detect the identity of the coupled device and/or communicate with the device through the multipurpose terminal block. In this context, detecting the identity may mean that the controller 102 is able to identify the coupled device as one of a category of devices (e.g., as a standard battery, an endurance battery, a diagnostic device, and/or a test device).

In some embodiments, the controller 102 may be disposed on a control board 114 of the chainsaw 100 that may include one or more other components, such as a memory block 116. In other embodiments, the controller 102 may be operatively coupled with more or less components than are shown in FIG. 1.

The detection and communication may be performed through one or more multipurpose contacts of the multipurpose terminal block 104 interfacing with the coupled device. In some embodiments, the same contact or contacts may be used for device detection and communication between the device and the controller (e.g., data input to the controller and/or data output to the device). The multipurpose terminal block 104 may further include one or more power contacts to route power to the controller 102 and/or other components of the chainsaw 100. The controller 102 may route the power to the motor 106 (e.g., if the trigger switch 110 is depressed) and/or other components of the chainsaw 100. For example, in an embodiment, the multipurpose terminal block 104 may include a positive power contact 112a and a negative power contact 112b to receive power, and a multipurpose contact 112c for device detection and/or communication. Other embodiments may include more or less contacts and/or a different arrangement of contacts than that shown in FIG. 1. In some embodiments, the trigger switch 110 may be either on or off, and the controller 102 may control the power directed to the motor 106.

In some embodiments, the controller 102 may determine the identity of the external device based on one or more parameters, such as a voltage level, detected via the multipurpose contact 102c. The controller 102 and/or devices may be configured to follow a voltage level protocol, wherein a certain type of device produces a voltage level at the multipurpose contact 102c within a range specified for that type of device. The devices may include a suitable structure (e.g., one or more resistors) to set the voltage level within the specified range. Additionally, the controller 102 may include a voltage detector to determine the voltage level on the multipurpose contact 102c. The voltage level protocol may include any suitable number of voltage level ranges for different types of devices. For example, the controller 102 may be configured to detect voltage levels within six ranges. Using exemplary ranges, a voltage level greater than 4.66 volts (V) may signal a fault condition; a voltage level between 4.66V and 4.34V may signal that the diagnostic device is coupled to the multipurpose terminal block; a voltage level between 4.33V and 3.82V may signal that a test device is coupled; a voltage level between 3.81V and 2.11V may signal that an endurance battery is coupled; a voltage level between 2.10V and 1.30V may signal that a standard battery is coupled; and a voltage level of 1.29V or below may signal a fault condition.

In some embodiments, the controller 102 may initiate detection of the coupled device when the trigger switch 110 of the chainsaw is activated. In other embodiments, the detection may occur automatically when a new device is coupled to the multipurpose terminal block (e.g., if the control board 102 receives a signal via one or more of the multipurpose contacts).

In various embodiments, the voltage level output to the controller on the multipurpose contact by the endurance battery and/or the standard battery may be different than a supply voltage of the battery. For example, in some embodiments, the supply voltage may be about 36V to about 40V.

In an embodiment, the battery may have a plurality of battery contacts. One or more of the contacts may be used for providing the voltage level to the controller for device detection, providing the supply voltage to the saw, and/or charging the battery. For example, in an embodiment, the battery may have first and second contacts for delivering power to the positive battery contact 112a and negative battery contact 112b, respectively, of the multipurpose terminal block 104, and a third contact for delivering the voltage level to the multipurpose contact 112c for device detection. The battery may include additional contacts for charging the battery (e.g., when coupled with a battery charger).

If a battery, such as the standard battery or an endurance battery, is coupled to the multipurpose terminal block, the positive and negative battery contacts may route battery power to the controller 102, which may then route power to the motor 106 and/or other components of the chainsaw. The differentiation of the type of battery connected, e.g., a standard battery or an endurance battery, may be used by the control board 102 to adjust a display (e.g., to represent a remaining power of the battery), and/or to determine one or more operating parameters of the saw. For example, the controller may set a power limit, e.g., a current limit, for the saw based on the type of battery. In some embodiments, the current limit set for the standard battery may be lower than the current limit set for the endurance battery. As an example, the current limit for the standard battery may be set to about 20 Amps (A), while the current limit for the endurance battery may be set to about 25 A. Accordingly, the chain speed and total available power may be greater for the endurance battery than the standard battery. Other power/current limits may be established as desired.

The display may visually represent a remaining power of the battery. For example, the display may show the remaining power as a percentage, as a graphical representation (e.g., a battery symbol that is filled in proportion to the amount of remaining power) and/or may show one or more symbols to advise of condition of the battery (e.g., a low power condition). In some embodiments, the display may include one or more indicators, such as light emitting diodes (LEDs) that light up according to a condition of the battery.

Upon detection of either the diagnostic device or test device, the controller 102 may use the multipurpose contact 112c for communication with the connected device. For example, the controller 102 may set the multipurpose contact 112c as a receiver and wait for a command from the connected device. Upon receiving the command, the controller 102 may take the appropriate action. In some embodiments, the controller 102 may also use the multipurpose contact 102 for transmitting information back to the attached device. Once the information has been sent, the controller 102 may convert the multipurpose contact back to a receiver and wait for another command. The diagnostic device and/or test device may include a controller for communicating with the chainsaw 100 via the multipurpose contact 112c and/or for carrying out other operations.

In some embodiments, the diagnostic device and/or test device may also provide power to the controller 102 and/or other components of the chainsaw 100 via the positive power contact 112a and negative power contact 112b. This may be necessary since the diagnostic device and/or test device may be coupled to the multipurpose terminal block 104 instead of a battery.

When the diagnostic device is coupled to the multipurpose terminal block 104, the diagnostic device may send one or more commands to the controller 102, such as to download data from the controller 102, reset the run time of the controller, and/or shut down the controller. The diagnostic device may download any suitable data stored on one or more memory blocks included in the controller 102 and/or accessible by the controller 102. Examples of data that may be retrieved by the diagnostic device include serial numbers for the chainsaw 100 and/or controller 102, the firmware version, data related to brake activations, the minimum and/or maximum current provided by the battery and/or delivered to the motor 106, logged faults, and/or maximum temperature. This data may be used by the diagnostic device to analyze performance, diagnose problems with the saw, and/or to aid in determining corrective actions. The run time reset command may signal the controller 102 to reset the run time to zero. The shutdown command may signal the controller 102 to safely shutdown.

Similarly, the test device may send one or more commands to the controller 102 when the test device is coupled to the multipurpose terminal block 104. For example, the test device may send a command to power down, run standard battery, run endurance battery, stop motor, save the saw serial number, and/or read data from the controller, such as the saw serial number, the controller serial number, the firmware version, the brake state, the motor maximum and/or minimum current, and/or the stop time. The run and stop commands may allow the saw to be placed into a test fixture and be run automatically. This may be advantageous to gather data on the chainsaw 100. The save saw serial command may allow the serial number to be saved for saw tracking purposes. The read commands may allow data to be uploaded and saved into a database for evaluation and tracking of the performance of chainsaw 100. The power down command may signal the controller 102 to safely power down.

In various embodiments, the data and/or error logging information may be stored on the memory block 116. This information may then be accessed by the diagnostic and/or test devices as explained above. The memory block 116 may be included in the controller 102 and/or may be a separate component from controller 102.

The data logged and/or stored in the memory block 116 may include the saw serial number, the controller serial number, the firmware version, run time, brake activations, minimum and maximum motor current, and/or maximum temperature.

The error logging may include a running log of faults up to a maximum number of faults, such as about 32 faults, and the corresponding run time at which the fault occurred. Once the maximum faults have been logged, additional faults may over-write the oldest fault so that a circular buffer of the newest 32 faults is maintained. Some or all of the faults in the running log of faults may be uploaded to the diagnostic device and/or test device to help diagnose problems.

In some embodiments, the faults may be divided into startup and running faults. The startup faults may detect a problem in the saw when the trigger is pulled to prevent the problem from causing damage to the saw or operator. These faults may include high and/or low battery ID, low battery voltage, over temperature, kick switch open, amplifier maximum and/or minimum offset, pulse-width modulation (PWM) high short, PWM low short, switch short, and/or low initialization voltage.

The running faults may monitor the saw condition while the chainsaw 100 is running and the chainsaw 100 may be powered off in case of a problem. This may protect the operator and/or the chainsaw 100. The running faults may include supply under voltage, over temperature fault, motor stall, motor over current, supply low voltage, and/or battery ID voltage low and/or high.

### Battery Alignment

In various embodiments, a battery may be placed into a battery compartment of the tool to supply power to the tool. In some embodiments, the compartment may be a multipurpose terminal, as described above. In some embodiments, the battery may provide relatively high power levels, such as from about 500 to 1000 watts. The battery may include female spring clips designed to receive male terminals on the tool. The female spring clips may be designed to handle some misalignment of the respective terminals at the given current levels. However, at greater degrees of misalignment, the resistance of the connection rises and excess heat is generated, which may reduce the efficiency and operating time of the battery. Accordingly, proper alignment of the battery, and retention of the alignment, may be important for operation of the tool.

In various embodiments, the battery compartment may include an alignment mechanism to guide the insertion of the battery into the compartment. For example, the compartment may have guide rails extending from the sides of the compartment, and the battery may include corresponding grooves. As the battery is inserted into the compartment the guide rails may be disposed within the grooves in the battery housing when the battery is inserted into the compartment. The guide rails may facilitate insertion of the battery and proper alignment of the battery in the compartment. For example, the guide rails may ensure that battery contacts on the battery housing are in contact with contacts in the compartment when the battery is fully inserted.

In some embodiments, the guide rails may have a plurality of distinct portions. For example, on a front portion of the guide rails, closest to the opening of the compartment, the guide rails may have a chamfer and/or angle to allow a greater misalignment of the guide rails with the grooves to facilitate insertion of the battery. A central portion of the guide rails may be substantially parallel and may allow for an intermediate tolerance of misalignment. The intermediate tolerance may substantially align the battery in the proper alignment while facilitating the battery grooves sliding on the guide rails. A rear portion of the guide rails may provide a tighter fit with the grooves, thereby providing a lower tolerance for misalignment. The rear portion may facilitate alignment of the battery contacts with the pins of the battery terminal in the compartment. Additionally, the tighter fit of the rear portion may prevent/reduce shifting of the battery in the event the tool is mishandled and/or dropped, which may prevent/reduce damage to the male terminals of the compartment. In some embodiments, the front portion may comprise about 10% of the length of the guide rails, the central portion may comprise about 75-80% of the length of the guide rails, and the rear portion may comprise about 10-15% of the length of the guide rails, although other arrangements are possible.

In other embodiments, the battery may include guide rails extending from the housing and the compartment on the tool may include grooves that guide the guide rails. In other embodiments, other configurations of corresponding elements on the battery and the compartment may be used.

In various embodiments, the battery and/or compartment may include a battery retention feature for maintaining the battery in position once the battery is fully inserted. For example, the compartment may include a spring-loaded latch having one or more latch fingers with a sloped front face (e.g., the side of the latch finger closer to the opening). As the battery is inserted into the compartment, the battery housing may depress the latch as it passes over the front face. When the battery is fully inserted into the compartment, the finger of the latch may snap into one or more retention structures (e.g., female latch features) in the battery housing. The latch may be coupled to a release mechanism which is accessible to the user when the battery is coupled in the compartment. The release mechanism may be activated to retract the latch from the female latch features of the battery housing so that the battery may be removed from the compartment. In some embodiments, the release mechanism may operate mechanically, such as through a lever arm.

In some embodiments, the battery may include a first female latch feature that temporarily maintains the battery in a partially inserted position and a second female latch feature that secures the battery in the fully inserted position. The first female latch feature may be configured to allow the battery to move in either direction along an insertion axis (e.g., the path of the guide rails) by application of force. For example, the first female latch feature may have a sloped rear wall that slopes toward the rear end of the battery, which may depress the latch finger if a pulling force is applied to the battery toward the opening of the compartment. The second female latch feature may have a vertical rear wall that may keep the battery securely in the fully inserted position unless the latch finger is retracted by the release mechanism.

In some embodiments, the compartment may further include a spring on the rear wall of the compartment. The spring may act on the battery to push it toward the opening of the compartment. When the latch finger is retracted, the spring may push the battery toward the opening of the compartment. The battery may stop in the partially inserted position when the latch finger reaches the first female latch feature. The battery may then be completely removed from the compartment by applying a pulling force to the battery from the partially inserted position.

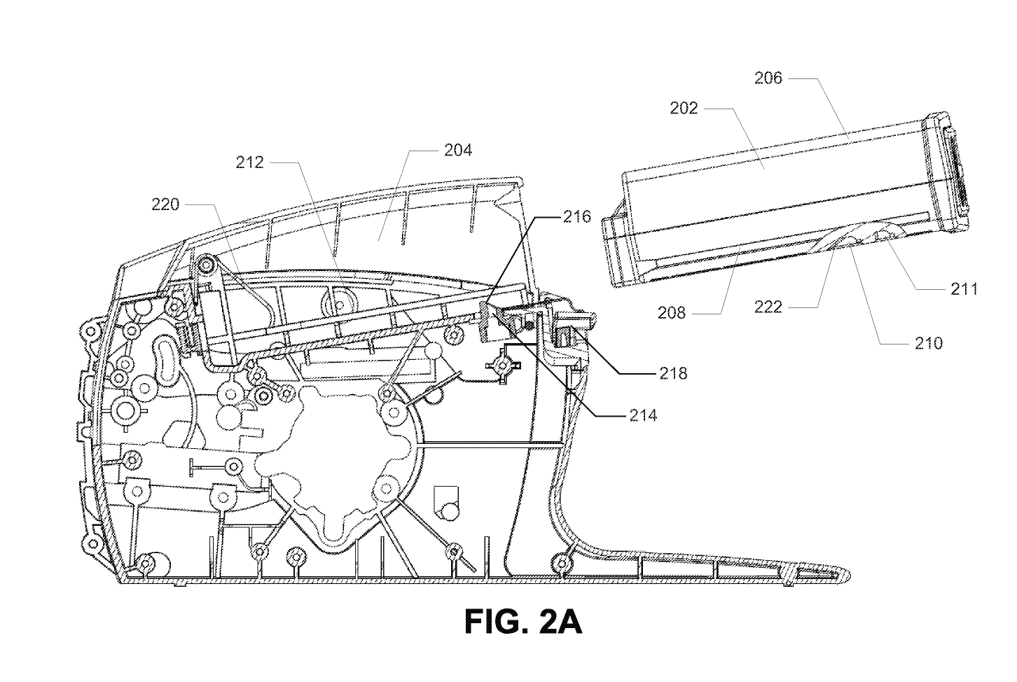

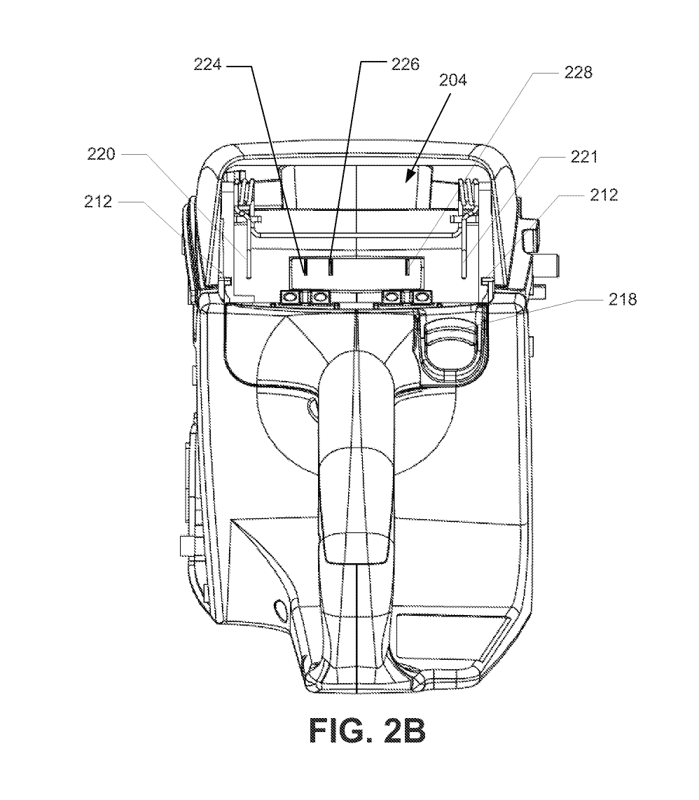

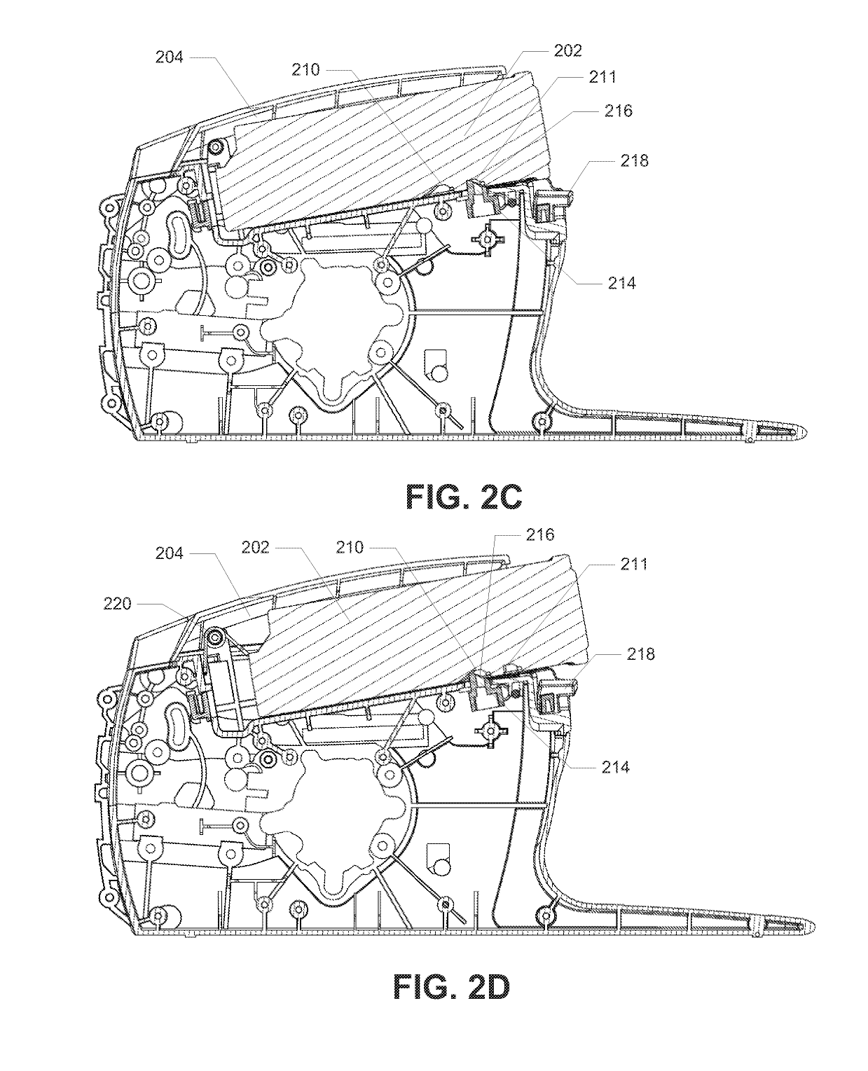

Various views of an embodiment of a battery 202 and a battery compartment 204 are shown in FIGS. 2A-D. Battery 202 includes a battery housing 206. Battery housing 206 has grooves 208 on each side and first and second female latch features 210 and 211, respectively, on the bottom side. Compartment 204 includes guide rails 212 on each side and a spring loaded latch finger 214 having a sloped front surface 216. As the battery 202 is inserted into compartment 204, grooves 208 slide on guide rails 212. Battery housing 206 pushes on sloped front surface 216, depressing latch finger 214. When battery 202 is in a fully inserted position, second female latch feature 211 is aligned over latch finger 214, allowing latch finger 214 to extend into second female latch feature 211 which secures battery 202 in compartment 204. Compartment 204 further includes terminal pins 224, 226, and 228 (shown in FIG. 2B) that couple with battery contacts on the battery (not shown) when the battery is in the fully inserted position.

Latch finger 214 is operatively coupled with a release 218, and forms a lever arm with release 218. Battery 202 may be moved from the fully inserted position (as shown in FIG. 2C) to a partially inserted position (as shown in FIG. 2D), by pushing up release 218, which retracts latch 214 from second female latch feature 211. When latch finger 214 is retracted, the force from spring arms 220 and 221, coupled to the rear wall of compartment 204, pushes battery 202 toward the entrance to compartment 204. This prevents latch finger 214 from re-entering second female latch feature 211. Latch finger 214 will spring up and engage first female latch feature 210, holding battery 202 in the partially inserted position. Battery 202 may be removed from compartment 204 by pulling on battery 202 while in the partially inserted position. A sloped portion 222 of first female latch feature 210 will push latch finger 214 downward as battery 202 is pulled out of compartment 204.

### Electronic Switch for Inertial Brake Mechanism

In various embodiments, the battery operated chainsaw may include brake assembly having an electronic brake and a mechanical brake. If the brake assembly is activated, the electronic brake may cut off power to the motor, and the mechanical brake may stop movement of the saw chain on the guide bar. The electronic brake may be activated by the user and/or automatically in response to sudden movement of the chainsaw, such as from a kickback event.

The brake assembly may include a brake paddle with a first end coupled to an electromechanical switch. The switch may be coupled to the control board and may act as a signal switch to identify the current state of the electronic brake (i.e., activated or deactivated). When the switch is in the activated state, electrical power may be shut off from the motor. Accordingly, the saw chain will no longer be driven by the motor, thereby making the saw chain easier to stop (e.g., by the mechanical brake). Additionally, the saw motor may not start up if the brake assembly is activated. In some embodiments, the switch activation may be logged (e.g., by the controller) for future diagnostics.

In some embodiments, a second end of the brake paddle may be operatively coupled with the mechanical brake. When the brake paddle is activated, the brake paddle may activate both the mechanical brake and the electronic brake with the same motion. Accordingly, the electronic brake may shut off power to the motor, thereby making it easier for the mechanical brake to stop the saw chain.

The switch may include a plunger to activate and/or deactivate the switch. For example, the switch may be in the deactivated state if the plunger is extended and may be in the activated state if the plunger is depressed. If the brake paddle is activated, the brake paddle may mechanically activate the switch by depressing the plunger on the switch. The switch may then send an electrical signal to the control board which identifies the activated state of the switch. In response, the control board may prevent operation of the motor (e.g., may prevent electrical power from being sent to the motor). Additionally, the mechanical brake may include a mechanical friction brake to quickly stop the movement of the saw chain.

The brake paddle may be activated manually and/or inertially. For example, the brake switching mechanism may include a brake trigger for manually activating the brake. Alternatively, or additionally, the brake may be activated inertially by movement of the chainsaw, for example due to a kickback event.

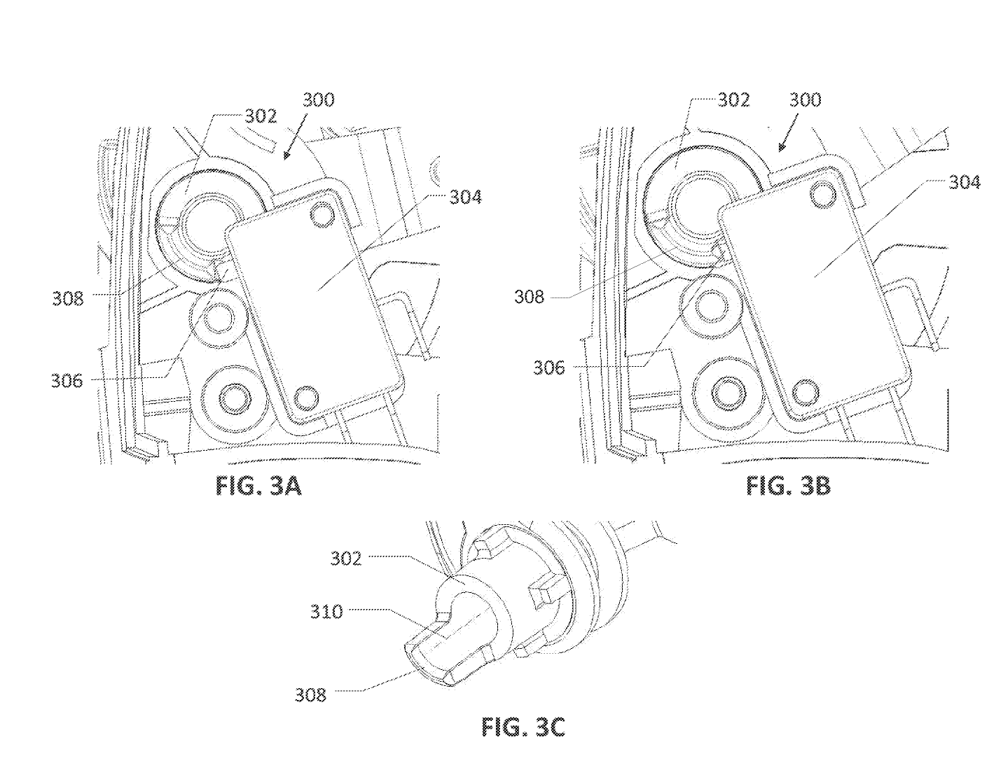

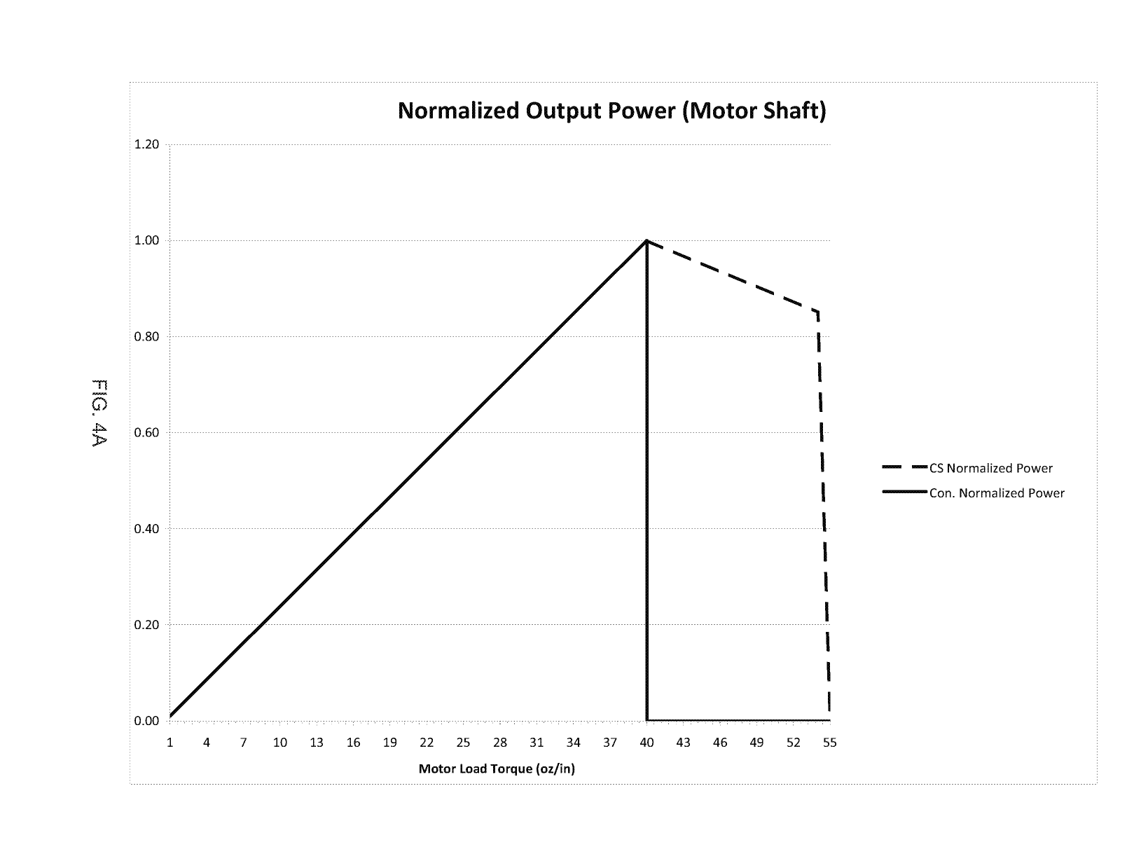

As shown in FIGS. 3A-B, brake switching mechanism 300 includes a brake paddle 302 coupled to an electromechanical switch 304. The switch 304 may be a snap-action switch that transitions from a deactivated state, as shown in FIG. 3A, to an activated state, as shown in FIG. 3B, when a plunger 306 is depressed. When in an activated state, the switch 304 sends a signal to the control board. The control board then may cut off power to the motor and prevent operation of the motor. As further shown in FIG. 3C, the brake paddle 302 includes an integrated switch activation cam 308, concentric to a pivot axis 310 of the brake paddle 302. Brake paddle 302 may be activated manually by the user and/or inertially by a kickback event. When brake paddle 302 is activated, the brake paddle rotates relative to the body of the chainsaw, and switch activation cam 308 depresses the plunger 306 of switch 304. In some embodiments, the brake paddle 302 may be designed to remain stationary when the body of the chainsaw rotates up and/or back upon reaching or exceeding a threshold level of inertia, such as may be present in a kickback event. Thus, as the body of the chainsaw rotates, the switch activation cam 308 may depress the plunger 306 and activate the switch 304.

On a second portion of the brake paddle 302 (not shown), the brake paddle 302 may activate a mechanical brake when brake paddle 302 is activated. The mechanical brake may stop the movement of the saw chain, such as through a mechanical friction brake. The mechanical brake may require less stopping force to stop the saw chain when it is not powered. Accordingly, by simultaneously activating the electronic brake, which cuts off power to the saw chain, and the mechanical brake, the mechanical brake may stop the saw chain faster and/or with less stopping force.

Due to the nature of the internal switch components, it is important to accurately and precisely activate the plunger to improve the reliability of the switch. Accordingly, the brake paddle and switch placement are configured to facilitate the movement of the plunger within switch specifications, thereby minimizing internal contact bounce and promoting high cycle life of the switch. In some embodiments, the software of the control board may include a signal conditioning buffer to prevent false activations when the tool is operated in a high vibration environment.

Operation of the brake paddle 302 through either manual or inertial activation in this manner may result in the optimal linear activation of the plunger 306 of switch 304. The brake paddle 302 may also activate a mechanical friction brake to quickly stop chain movement, thereby reducing risk to the operator and the tool.

The switch 304, in combination with the brake paddle 302, may enable a faster chain stop time (e.g., in case of a manual trigger and/or a kickback event, and also may reduce the possibility of damage to other electrical components of the saw including the control board and/or motor.

### Tool Feel Enhancements

In various embodiments, a control algorithm is applied to a battery operated tool to control an output power of the tool as a workload is placed on the tool. This control may prevent damage to components of the tool from overload, particularly when workload is increased past a threshold load. In various embodiments, the control system may taper off at least one of a voltage and/or duty cycle of a pulse-width modulation (PWM) control signal at a predetermined set point of the applied workload. In various embodiments, the set point may correspond to a duty cycle that is less than 100% duty cycle. The motor current may increase past the set point, while the motor voltage is reduced. This may provide a gradual decay in output power past the set point, thereby providing enhanced tool feel to the user.

The output power response provided by the control algorithm may emulate the expected response of a tool driven by an internal combustion engine, thereby providing enhanced tool feel to the user. An internal combustion engine has a large operating window, e.g., power band, in which the engine is producing an arbitrary percentage of its peak power. The power band may be defined by the motor speed and/or motor load that correspond to peak output power of the tool. An internal combustion engine commonly has a power increase as speed of the engine increases until peak power is reached, and then power tapers off gradually in a curve that resembles a bell curve. The upper end of this power curve is the power band. A user may obtain best performance by operating the tool within the power band. The user may adjust the workload placed on the tool (e.g., by adjusting the force applied to a workpiece) if the user senses a drop in output power. In a tool with an internal combustion engine, dropping off the power band by too little load (e.g., the low end of the power band) or too much load (e.g., the high end of the power band) may be easily felt by the user.

In contrast, in a conventional battery operated tool, the power band is very small. The output power of a conventional battery operated tool increases as the speed of the motor increases until the peak power is reached, and then output power drops off sharply. A user may obtain best performance by operating the tool at peak power, and the user may adjust the workload placed on the tool (e.g., by adjusting the force applied by the tool to a workpiece) if the user feels a power drop. In a conventional battery operated tool, dropping off the low end of the power band (e.g., having too little load) is easily felt. However, as the workload exceeds peak power, the output power decreases rapidly, which often causes the motor to stall. It may be difficult for the user to feel that the upper end of the power band has been reached in order to adjust the workload before the motor stalls.

In various embodiments a direct current (DC) electric motor of a battery operated tool may be controlled and/or operated by regulating and/or limiting the current (and/or voltage) applied to the motor. The torque produced by the motor may be proportional to the current applied to the motor (e.g., according to a torque constant of the motor). The motor torque may be applied to an output shaft coupled to the motor. The output power of the motor is the product of motor speed and torque.

Various embodiments may provide a control system including a control algorithm used to control a pulse-width modulation (PWM) controller to provide a PWM control signal to the motor. The PWM control signal may have a duty cycle that is adjusted by the PWM controller. The control system may alternate between applying the battery voltage to the motor to induce motor current (e.g., during the high portion of the control signal duty cycle) and shorting the motor to re-circulate the current (e.g., during the low portion of the control signal duty cycle). The motor's armature inductance may average the currents induced and/or re-circulated to provide a consistent output power.

Current limiting may be required to operate various components of the tool, such as a battery, DC motor, motor controller, and/or mechanical transmission, within parametric operating bounds and/or for user safety reasons. In conventional battery operated tools, current limiting causes a sharp decay in output power when the tool load passes a threshold load, e.g., the current limit. In a DC motor operated by a PWM circuit, as the motor current is increased in response to increased tool load, the duty cycle of the PWM signal is increased. Once the PWM signal reaches 100% duty cycle, the voltage must drop off to zero, which causes a steep drop off in output power as discussed above. Accordingly, a minimal increase in tool past the threshold load may cause a very rapid output power reduction once the current limit threshold is reached, which may result in a stalled tool, user fatigue, user frustration, and/or compromised productivity.

In various embodiments, the workload applied to the chainsaw as the chainsaw operates on a workpiece may vary based on the force with which the operator applies the saw chain to the workpiece and/or the length of the saw chain that is in contact with the workpiece. For example, if an operator uses a chainsaw to cut through a circular log, the workload will increase as the saw penetrates the log and will reach a maximum workload at the center of the log (where the cross section has the greatest width). Similarly, the workload may increase if the operator applies more force to the workpiece with the saw.

In various embodiments, the control system may taper off at least one of the voltage and/or duty cycle of the PWM control signal at a predetermined set point of the applied workload. The set point may correspond to a duty cycle of the PWM control signal that is less than 100% duty cycle. For example, the set point may be about 50% to about 100%. The current may be allowed to increase past the set point to maintain the desired power of the control signal. As the user continues to load the saw, the motor speed may drop but the torque may rise, which prevents a sharp drop in power. The voltage of the motor may decrease by decreasing the duty cycle of the signal as tool load increases past a threshold. The current to the motor may increase as tool load increases past a threshold.

Accordingly, the control system may increase the current of the PWM control signal as the voltage decreases. This may increase the torque of the motor while decreasing the speed of the motor, thereby causing the output power to taper off gradually past the set point (e.g., providing a power curve resembling a bell curve). The gradual decay in output power may provide enhanced tool feel to the user. The user may sense that the tool has exceeded peak power, thereby allowing the user to reduce the load on the tool to operate the tool at or near peak power (e.g., in the power band).

In various embodiments, the control system may operate at or near the maximum permissible battery current as tool load is increased past the set point. The duty cycle of the PWM control signal may drop off past the set point, causing motor current to increase as motor voltage decreases. This may prevent the output power of the motor from dropping off dramatically.

To illustrate by way of example, the PWM may operate at a continuous frequency, such as 20 KHz, so that a maximum “on time” of the sourcing switch, equating to a duty cycle of 100%, is 50 μs. At a 100% duty cycle, the average voltage applied to the motor may be equal to the battery voltage, and the battery current may be equal to motor current.

As the duty cycle of the PWM is reduced, the motor voltage may be (battery voltage)×(duty cycle) and the battery current may be (motor current)×(duty cycle). For example, if the PWM duty cycle drops to 50% (25 μs), the equivalent motor voltage would be half of the battery voltage, and the battery current would be half of the motor current. In this case, if motor current is programmed to be 20 Amps (A), the battery would be required to deliver 10 A.

In some embodiments, the battery may have a maximum discharge current rating of, for example, about 20 A. Accordingly, when the tool is loaded past the 20 A battery current limit, motor current may be increased to 40 A, while maintaining a battery current at the battery's capability, yielding twice the motor current at one half the motor voltage (since the average applied motor voltage may be (battery voltage)/2). As motor torque relates directly to motor current and motor speed relates directly to motor voltage, the example demonstrated above results in about twice the motor torque and about one half the motor speed while the power remains high as power is the product of motor torque (motor current×motor speed (motor voltage). This high power extends the power of the tool at the 20 A limit of the battery creating a large power band. The upper end of the power band has lower motor speed to provide tool feel to the user which may facilitate the balancing of tool load by the user to obtain efficient tool utilization.

In practical application, additional parametric bounds may be placed on the control system's functionality. For example, bounds may be imposed by the motor's maximum current handling capability, the current rating of the controller, and/or the torque rating of the mechanical transmission.

As explained above, available motor current while maintaining the battery's maximum current rating may be expressed as (Battery Max Current)/(PWM Duty Cycle) where duty cycle is expressed in the range of 0 to 1.

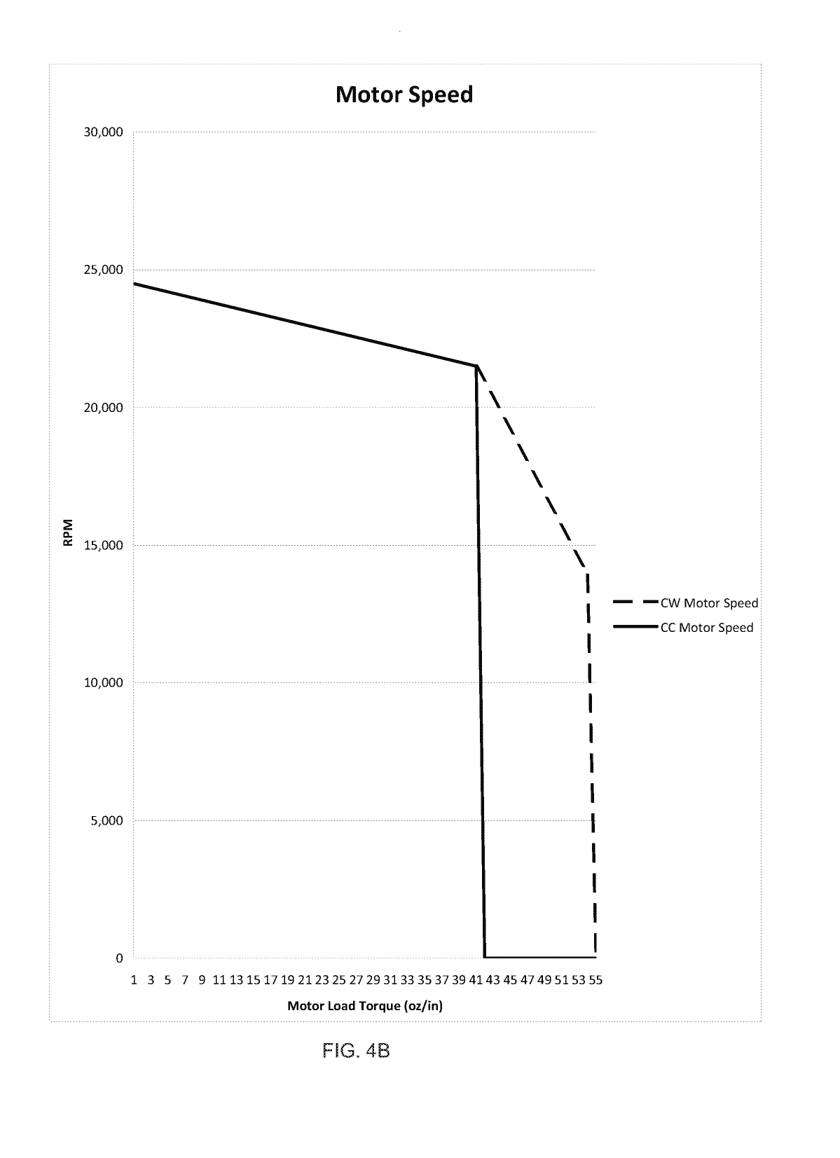

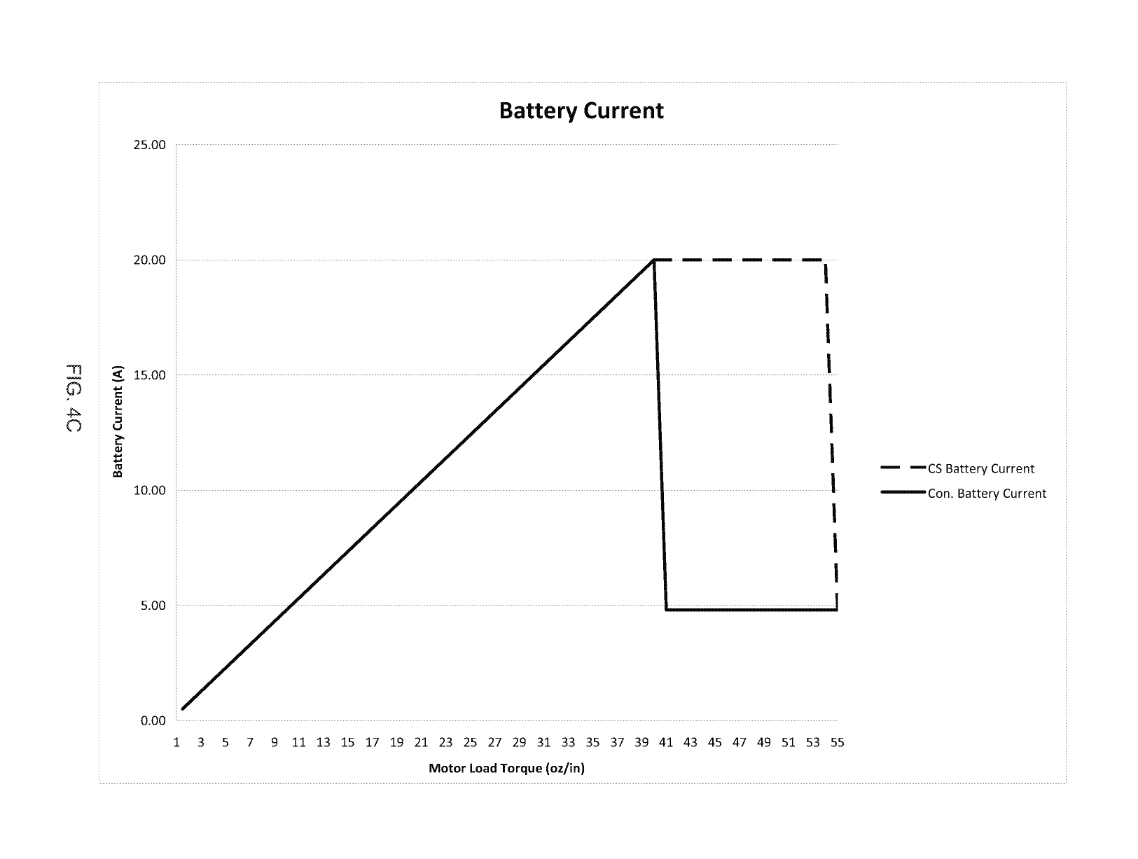

The data plots in FIGS. 4A-D depict the advantage of the control system's motor control (in dashed lines and labeled CS) compared with conventional battery operated tool (in sold lines and labeled Con.). The plots graph motor output power (FIG. 4A), motor speed (FIG. 4B), battery current (FIG. 4C), and motor current (FIG. 4D) as a function of motor (tool) load.

In various embodiments, a controller (e.g., the controller 102) may carry out the control algorithm described herein. In some embodiments, the control algorithm may be implemented exclusively with software and/or firmware (e.g., stored on and/or accessible to the controller). This design may minimize recurring costs of manufacture. In other embodiments, the control algorithm may be implemented exclusively in hardware and/or in a hybrid employing discrete hardware for the PWM controller and a firmware implementation to control the PWM controller.

### Thermal Management

In various embodiments, a thermal management system for a tool may be provided that may cool one or more components of the tool, such as a control board and/or a motor. The tool may be a battery powered tool, such as a battery powered chainsaw. The thermal management system may allow the tool to operate at temperature extremes without damaging the tool. In various embodiments, the thermal management system may route motor intake air over (e.g., adjacent to) the control board to cool circuitry on the control board. The motor intake air may be routed over the control board prior to and/or after being routed to the motor to cool the motor.

In various embodiments, the control board may include a controller as discussed herein. The thermal management system may use one or more methods for cooling the components, such as managing air flow through an air inlet, managing air flow through an air exhaust, and/or thermal management functions of the control board. The control board may be configured to perform one or more thermal management functions, such as heat removal, temperature monitoring, and/or tool control.

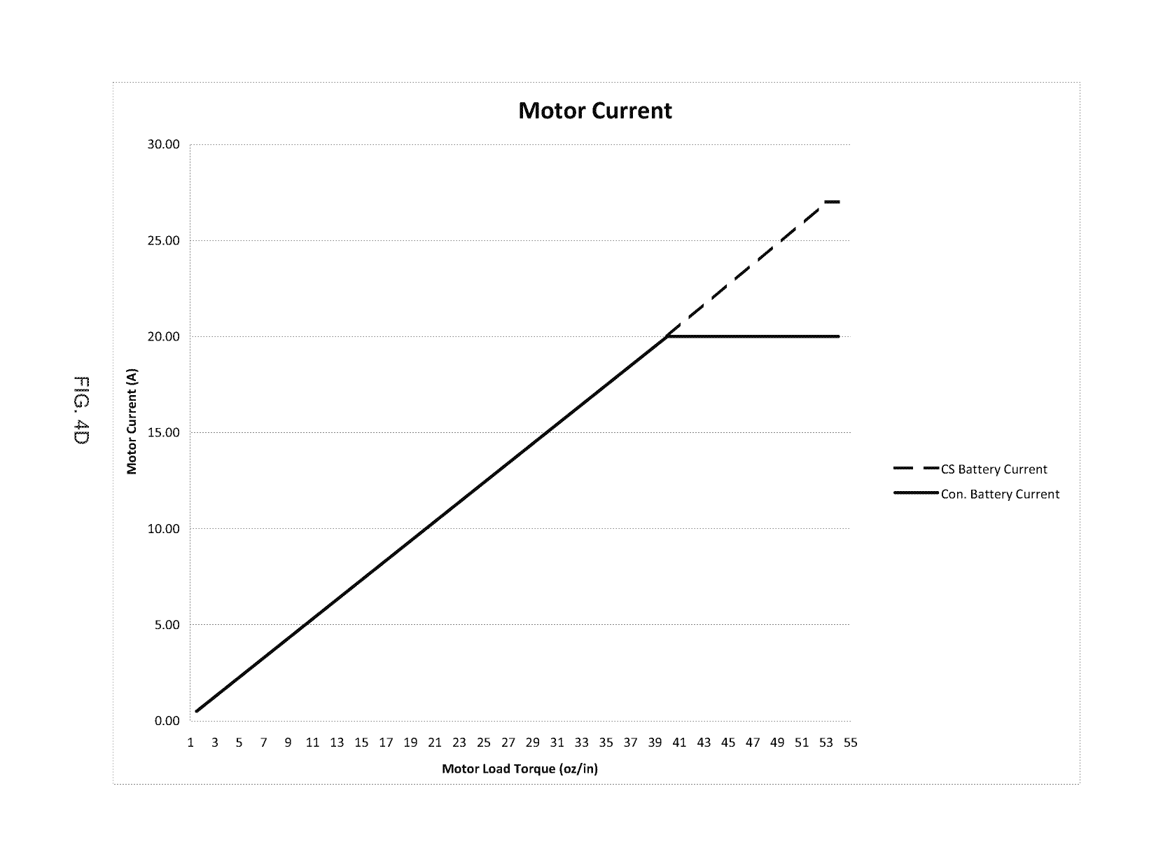

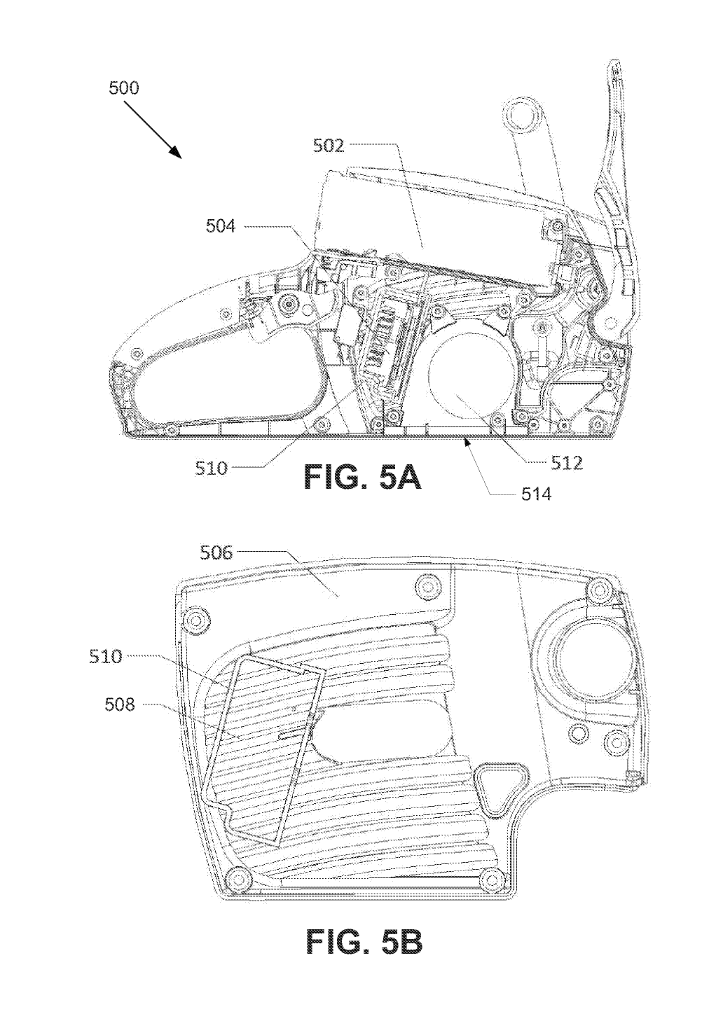

In various embodiments, the thermal management system may utilize an internal fan of the motor. The internal fan may intake a significant amount of air, such as about 300 liters of air per minute. FIG. 5A shows a cross-section of a chainsaw 500 having a saw body 502 and a control board 504. A motor cover 506, as depicted in FIG. 5B, may be coupled to the saw body 502. Intake air may enter the saw body 502 through controlled inlets 508 in the motor cover 506. The internal fan of the motor may facilitate intake of air through inlets 508. An air passage 510 may be coupled to the saw body 502. The control board 504 may be disposed inside the air passage 510. The air passage 510 may route the intake air across the control board 504. The air may clear heat produced by the control board 504 and/or cool the control board 504 as the air passes through the air passage 510. The air passage 510 may be sealed so that substantially all air entering through controlled inlets 508 passes through air passage 510.

The heat output of the control board 504 may increase under high temperatures, high load applied to the chainsaw 500, and/or high duty cycle of the motor control signal (e.g. the power signal as described herein). For example, the thermal losses of control board 504 may be about 50 to 75 Watts at normal operating conditions and duty cycle. At extreme temperatures and/or duty cycle the air passage 512 may remove up to 150 to 225 Watts of heat.

In some embodiments, the air exiting from the air passage 510 may lead directly to a primary motor intake (not shown) at an output shaft end of the motor. The output shaft end of the motor may also be the location of motor interface/mounting to a gear box. The output shaft end of the motor may intake a portion of the inlet air, such as about 80% of the inlet air. The primary motor intake may include one or more inlet ports, such as about four inlet ports. The air entering the inlet ports at the output shaft end of the motor may cool the motor. The heat output of the motor may increase at high temperatures and/or duty cycles. For example, the motor during normal operating conditions and duty cycles may put off about 100 to 200 Watts of heat. At extreme temperatures and/or duty cycles, the motor may produce about 200 to 400 Watts of heat.

The air exhaust from the motor may exit the motor into an exhaust shroud 512. The design of the exhaust shroud 512 may provide maximum air flow in the confined space inside the saw body 502 taking into account the rapid expansion of the heated air as it exits the compressed state of an impeller fan. In some embodiments, the design of the exhaust shroud 512 may substantially resemble a nautilus.

The thermal management system may further include outlet vents on a bottom surface 514 of the chainsaw 100. These vents may be oriented to be in direct alignment with the outward exhaust of the exhaust shroud 512, such as the outward spiraling exhaust as directed by the nautilus shape of the exhaust shroud 512. The nautilus shape of the exhaust shroud 512 may allow the outlet vents to be disposed on the bottom surface 514 rather than on a front side of the chainsaw 100. The outlet vents may direct exhaust air in a vertical manner.

In various embodiments, the inlets 508 and outlet vents may be oriented on the saw body 502 to prevent and/or reduce wood chips or other debris from entering the saw body 502. For example, the inlets 508 may be located on the side of the saw body 502 opposite the chip generation side. In some embodiments, the chip generation side may be the side of the tool 500 closer to the blade bar (e.g., in embodiments in which the blade bar is offset to one side, as discussed further below). As the chain traverses the blade bar, the chain may carry chips from the workpiece (e.g., a log) back to the chip generation side of the tool 500. Additionally, the location of the outlet vents on the bottom surface of the saw body 502 may push chips downward and/or away from the inlets 504.

Additionally, the sealed air passage 510 may provide relatively rapid air flow to clear any chips or debris that may enter the inlets 508.

In various embodiments, the control board may be designed to facilitate removal of heat produced by components of the control board. The control board may be an assembly of a plurality of components and/or sub-assemblies, such as a heat sink, a gap pad, an electronic circuit board assembly (ECA), potting epoxy, and/or a potting tray.

The ECA may include one or more silicon switches, such as Field Effect Transistors (FET), that generate heat. The FETs may regulate the power, e.g., current flow, to the motor at a relatively high power level, and may also generate heat due to their inherent operation. The FETs may be relatively efficient if they are working within their normal operating temperature range. For example, the normal operating range of the FETs may be about 30 to about 100 degrees Celsius. Outside of their normal operating range they may lose efficiency at a nonlinear rate and eventually lead to failure. The tool may not function with a failed FET. Therefore it may be important to remove heat from the FETs to maintain the FETs in their normal operating temperature range.

In some embodiments, the FETs may be mounted upside down on the control board so that the thermal bases of the FETs are coupled to the heat sink rather than the printed circuit board. The contacts of the FET may be bent to couple with other components of the control board. Coupling the thermal base of the FETs to the heat sink may increase the effectiveness of the heat removal.

However, the plurality of FETs must be electrically isolated, so they may not be directly connected to the heat sink. Accordingly, a compound that is thermally conductive and electrically isolating may be placed between the FETs and the heat sink in order to take advantage of the heat transfer capacity with the FETs upside down but maintain electrical isolation. For example, suitable compounds may include Bergquist Gap Filler GF3500S35-07.

Additionally, micro glass beads/spheres, such as micro glass beads/spheres, may be added to the compound to ensure that a minimum gap is maintained between the FETs and the heat sink, such as about 0.15 mm, as defined by the size of the beads/spheres. The minimum gap provided by the beads/spheres may allow thermal conductivity while limiting the risk of electrical contact between the FETs. Special care may also be taken to allow for the physical stack of the components, especially the heat standoffs and/or FET contact zone that may be precisely machined.

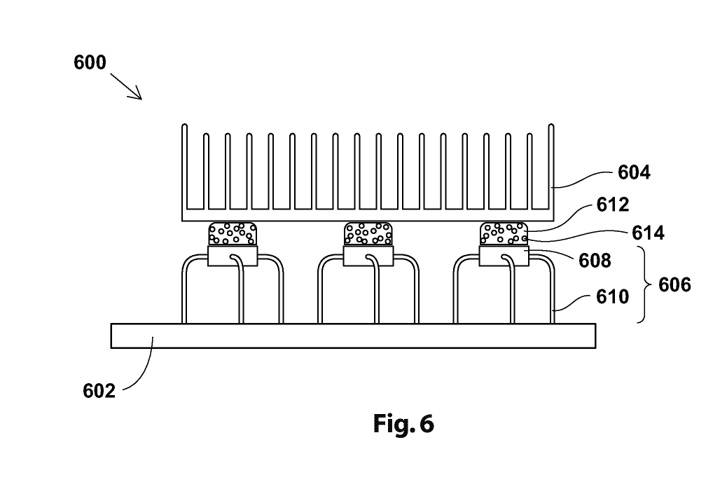

FIG. 6 shows a control board 600 having a printed circuit board 602, a heat sink 604, and a plurality of FETs 606. Thermal bases 608 of the FETs 606 are coupled to the heat sink 604. Contacts 610 of the FETs 606 are coupled to the printed circuit board 602. A layer of compound 612 is disposed between the thermal bases 608 of FETs 606 and the heat sink 604. Compound 612 is electrically isolating to isolate the FETs 606 from one another and thermally conductive to facilitate heat transfer of the heat sink 604. Micro-glass beads 614 are included in the layer of compound 612 to provide a suitable gap between the FETs 606 and the heat sink 604.

In various embodiments, the controller (e.g., through firmware) may detect the temperature on or near the control board and adjust parameters of the system, such as the duty cycle, in response to an increased temperature. For example the controller may decrease the current threshold and/or duty cycle of the control signal sent to the motor if the controller detects operation at an elevated temperature.

In some embodiments, the ECA may further include a thermistor to detect a temperature at one or more of the FETs. The output signal of the thermistor may be fed into the processor and compared to a reference value. The reference value may be correlated (e.g., through experimentation) to the temperature at the FET. This comparison may be done by firmware on the processor. In some embodiments, the comparison may occur with a relatively high frequency, such as about 100 to 500 times per second. The correlation may be required (e.g., as opposed to directly comparing the temperature detected by the thermistor with the maximum FET operating temperature) since the thermistor is not part of the FET and is located spaced apart from the FET on the circuit board. The correlation may be used to determine the temperature at the FETs.

The processor may adjust operation of the chainsaw depending on the temperature of the FETs. In some embodiments, the firmware may include two predetermined limits, a first limit and a second limit. If the thermistor reaches the first limit, the processor may initiate a cool down mode as a precaution. The cool down mode may reduce the current of the power signal to the motor. For example, the processor may reduce the current flow in the FETs by an amount relative to the amount the temperature is above the first limit, so as the temperature goes up, the current limit is lowered. The processor may run the motor in cool down mode until the temperature detected by the thermistor drops below the first limit.

If the saw is unable to cool down, the second limit may be reached. This may happen, for example, when operating in extreme ambient temperatures and/or duty cycles. If the second limit is reached the processor may shut down the saw (e.g., shut off power to the motor).

### Balanced Center of Gravity

In various embodiments, components of the battery powered chainsaw, such as the battery, motor, and/or gear box, may be placed in a housing of the chainsaw so as to have the center of gravity of the tool in proper placement for the operator to achieve optimum stability and control of the tool. The placement of the center of gravity in relation to the operator's main contact points, such as a front handle and a rear handle, may provide a reduction of operator fatigue as well as increased safety. In some embodiments, the center of gravity may be located so that the chainsaw is substantially horizontal (e.g., with a guide bar of the chainsaw oriented substantially parallel with the ground) or tilted slightly upward if the chainsaw is grasped by the front handle. Accordingly, the center of gravity may be below and slightly behind the front handle.

The placement of the center of gravity may also provide feedback (sensitivity) from the tool's cutting which creates heightened operator awareness of the cutting process. Additionally, in some embodiments, the battery and/or other components of the chainsaw may be arranged so that different batteries having different weights may be used without substantially changing the center of gravity.

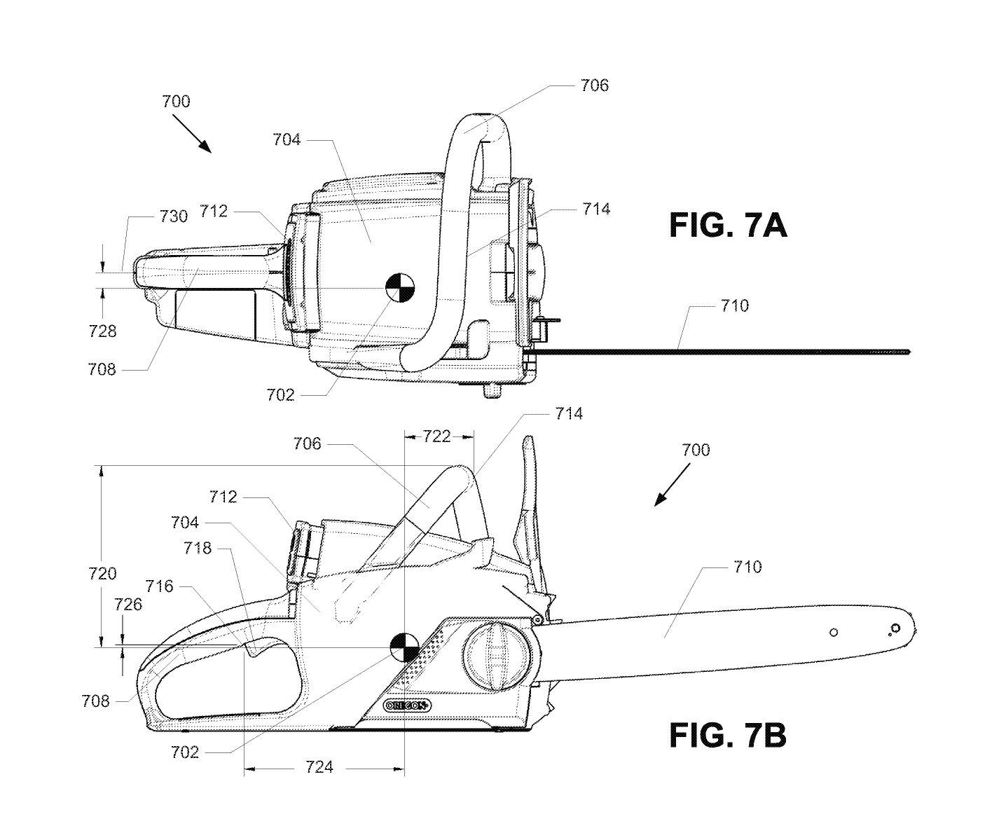

FIG. 7A shows a top view and FIG. 7B shows a side view, respectively, of a chainsaw 700 with a center of gravity 702. Chainsaw 700 includes a housing 704, a front handle 706, and a rear handle 708. The front handle 706 extends above the housing 704, and the rear handle 708 extends behind housing 704. A guide bar 710 extends in front of housing 704 and may include a saw chain (not shown) disposed thereon. The housing 704 may at least partially contain a battery 712 and a motor (not shown). During operation of the chainsaw 700, the user may grasp the front handle 706 at or near a first contact point 714, and may grasp the rear handle 708 at or near a second contact point 716 (e.g., adjacent a trigger switch 718).

In various embodiments, the center of gravity 702 may be below and slightly behind the first contact point 714 of the front handle 706. This center of gravity may create a stable and comfortable position for the user. For example, as shown in FIG. 7B, the center of gravity 702 may be a first distance 720 below the first contact point 714 (e.g., in the y-direction) and a second distance 722 behind the first contact point 714 (e.g., in the x-direction). In one embodiment, the first distance 720 may be about 140 to 180 millimeters, such as about 160 millimeters, and the second distance 722 may be about 40 millimeters to about 80 millimeters, such as about 60 millimeters. Additionally, the center of gravity 702 may be a third distance 724 in front of the second contact point 716 of the rear handle 708 (e.g., in the x-direction), and a fourth distance 726 above the second contact point 716 (e.g., in the y-direction). In one embodiment, the third distance 724 may be about 120 to about 160 millimeters, such as about 140 millimeters, and the fourth distance 726 may be about −20 millimeters (e.g., 20 millimeters below the second contact point 716) to about 20 millimeters, such as about zero millimeters (e.g., even with the second contact point 716).

In some embodiments, the position of the battery 712 in the housing 704 may be configured so that batteries 712 of different weights may be used without substantially changing the center of gravity of the chainsaw. For example, the chainsaw 700 may be configured to be used with different batteries, such as a standard battery and/or an endurance battery. The different batteries may have different weight characteristics (e.g., total weight and/or distribution of weight). For example, the standard battery may have about ten cells, and the endurance battery may have about 20 cells. In that case, the endurance battery may be about twice as heavy as the standard battery.

Accordingly, in some embodiments, the battery 712 and/or chainsaw 700 may be configured so that the center of gravity 702 stays within an acceptable range when one or more of the plurality of batteries is/are used. In some embodiments, the acceptable range may be a shift of the center of gravity about 20 millimeters or less in any one direction (e.g., x-direction, y-direction, and/or z-direction). In one embodiment, the chainsaw 100 and/or battery 712 may be designed so that the center of gravity does not change substantially for batteries of different weights.

As shown in FIGS. 7A and 7B, the battery is placed between the front handle 706 and the rear handle 708, near the top of housing 704. This orientation of battery 712 may facilitate having the center of gravity 702 in the desired location and/or maintaining the center of gravity 702 within the acceptable range for batteries of different weights.

Other components of the chainsaw 700, such as the motor and/or gearbox, may also be arranged to achieve the desired center of gravity 702.

In some embodiments, the center of gravity 702 may be longitudinally offset to one side of the chainsaw 700 (e.g., in the z-direction, perpendicular to the cutting plane of the guide bar 710). For example, in some embodiments, the guide bar 710 may be offset to one side of the chainsaw 700, as shown in FIGS. 7A and 7B. The center of gravity 702 may be offset toward the guide bar 710. This offset may compensate for the offset mass of bar 710 and the saw chain and/or cutting forces. As shown in FIG. 7A, the center of gravity 702 is offset a fifth distance 728 from a longitudinal center plane 730 of chainsaw 700. In one embodiment, the fifth distance 728 may be about zero to about 40 millimeters, such as about 15 millimeters.

In various embodiments, the front handle 706 of the chainsaw 700 may have a wide area for the operator to grip, allowing adjustment of longitudinal hand position (e.g., to compensate for a changing cutting load and/or reaction forces on the chainsaw 700).

The rear handle 708 may provide hand positions for which the placement of center of gravity 702 as disclosed herein may offer improved stability and/or control of the tool. The rear handle 708 may be offset from the guide bar 710 for safety and/or may be substantially behind the front handle to allow the operator to control reaction forces resulting from cutting.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

1. A battery-powered handheld tool, comprising:
a controller; and
a multipurpose terminal block coupled to the controller, the multipurpose terminal configured to be coupled with an external device and the multipurpose terminal including at least one multipurpose contact,
wherein the controller is configured to identify the external device and communicate with the external device via the multipurpose contact.

2. The tool of claim 1, wherein the controller is configured to identify the external device based on a voltage level at the multipurpose contact.

3. The tool of claim 1, wherein the controller is configured to identify whether the external device is a battery, a diagnostic device, or a test device.

4. The tool of claim 1, wherein the controller is configured to identify whether the external device is a standard battery or an endurance battery.

5. The tool of claim 4, further comprising a motor coupled to the controller, and wherein the controller is configured to set a power limit of the motor based on the identification of the external device as a standard battery or an endurance battery.

6. The tool of claim 1, wherein the multipurpose terminal block further includes a pair of power contacts configured to deliver power from the external device to the controller.

7. The tool of claim 1, further comprising a trigger switch coupled to the controller, wherein the controller is configured to identify the external device if the trigger switch is activated.

8. The tool of claim 1, wherein the controller is configured to transmit stored data to the external device via the multipurpose contact.

9. The tool of claim 8, wherein the stored data includes data related to one or more fault conditions.

10. The tool of claim 9, wherein the one or more fault conditions include one or more startup faults detected when a trigger of the tool is activated and/or one or more running faults detected while the tool is running.

11. The tool of claim 1, wherein the controller is configured to carry out one or more commands received from the external device via the multipurpose contact.

12. An accessory for a battery-powered handheld tool, comprising:
a body configured to mate with a terminal block of the handheld tool;
a multipurpose contact coupled to the body and configured to communicatively couple with a first contact of the handheld tool; and
a voltage generation structure configured to produce a voltage level at the multipurpose contact so that the handheld tool can identify the accessory based on the voltage level.

13. The accessory of claim 12, further comprising first and second power contacts configured to supply power to the handheld tool.

14. The accessory of claim 13, wherein the accessory comprises a battery.

15. The accessory of claim 13, further comprising a controller configured to communicate with the handheld tool via the multipurpose contact.

16. The accessory of claim 15, wherein the accessory comprises a diagnostic device or a test device.

17. The accessory of claim 15, wherein the controller is configured to retrieve stored data from the handheld tool.

18. The accessory of claim 17, wherein the stored data includes data related to one or more fault conditions.

19. The accessory of claim 15, wherein the controller is configured to command the handheld tool to run a test protocol.

20-65. (canceled)
